(19) United States
(12) Patent Application Publication
(10) Pub. No.: US 2005/0231684 A1
(43) Pub. Date: Oct. 20, 2005

(54) Eyeglass frame

(75) Inventor: Kaoru Tokumaru, Awara-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Kabushikikaisha Sanmei

(21) Appl. No.: 10/901,235

(22) Filed: Jul. 29, 2004

(30) Foreign Application Priority Data
Apr. 16, 2004 (JP) 2004-121103

(51) Int. Cl. G02C 13/00

(52) U.S. Cl. 351/178

(57) ABSTRACT

An eyeglass frame is provided. The eyeglass frame includes a frame portion fabricated from a Ti alloy having at least one of a superelastic characteristic and a shape-memory characteristic. The Ti alloy is free from Ni.

### CROSS REFERENCE TO RELATED APPLICATION

This application is based upon and claims the benefit of priority from Japanese Patent Application No. 2004-121103, filed on Apr. 16, 2004, the entire content of which is incorporated herein by reference.

### FIELD OF THE INVENTION

The present invention relates to an eyeglass frame. More particularly, the invention relates to a frame material for a pair of glasses that reduces skin irritation and deformation problems.

### BACKGROUND OF THE INVENTION

In recent years, a frame for a pair of glasses that is strongly deformation resistant and uses a Ti alloy, which has superelastic and shape-memory characteristics, has been provided. A Ti—Ni alloy and a Ti—Ni-base alloy, such as a Ti—Ni—Co alloy and a Ti—Ni—Cu alloy, are known Ti alloys. However, when Ni, which is one of the elements of the Ti—Ni-base alloy, is used for a frame for a pair of glasses and makes contact with a user's skin, the user may suffer from a certain type of allergic reaction to metal and skin irritation. Also, Ni may be carcinogenic.

A Cu—Zn—Al alloy is a superelastic and shape-memory alloy that does not contain Ni. However, it is pointed out that the Cu-base alloy has low strength. Also, Cu or Zn may cause skin irritation, and Al may cause a certain type of dementia. Consequently, the Cu-base alloy is not suitable for a frame material for a pair of glasses.

Therefore, an eyeglass frame that addresses the above problems is desired. It is also desirable to provide a frame material for a pair of glasses that does not cause skin irritation generally and has the superelasticity and the shape-memory characteristics. A frame for a pair of glasses using such a material is desired.

### SUMMARY OF THE INVENTION

An eyeglass frame is provided. The eyeglass frame includes a frame portion fabricated from a Ti alloy having at least one of a superelastic characteristic and a shape-memory characteristic. The Ti alloy is free from Ni.

It is to be understood that both the foregoing general description and the following detailed description are exemplary and explanatory only and are not restrictive of the invention, as claimed.

The accompanying drawings, which are incorporated in and constitute a part of this specification, illustrate embodiments of the invention and together with the description, serve to explain the principles of the invention.

### BRIEF DESCRIPTION OF THE DRAWINGS

FIG. 1 is an eyeglass frame according to one exemplary embodiment;

FIG. 2 illustrates a portion of the eyeglass frame of FIG. 1;

FIG. 3 illustrates graphs of stress values (σ) with respect to shape recovery elastic strain (εₑ) for a superelastic material and a nonsuperelastic material; and

FIG. 4 illustrates superelasticity of an eyeglass frame according to one embodiment.

### DESCRIPTION OF THE EMBODIMENTS

Reference will now be made in detail to the present embodiment (exemplary embodiment) of the invention, an example of which is illustrated in the accompanying drawings. Wherever possible, the same reference numbers will be used throughout the drawings to refer to the same or like parts.

According to one exemplary embodiment, the eyeglass frames uses a superelastic Ti alloy that does not contain elements that may cause skin irritation, such as Ni. The frame material for a pair of glasses in the embodiment is a Ti alloy that does not contain Ni and has at least either a superelastic characteristic or a shape-memory characteristic. The frame material for a pair of glasses may be used for a rim, a temple, a bridge, a joint between the temple and the bridge, a brace bar, and their intermediaries.

Furthermore, the Ti alloy may not include V, Al, Cd and Tl. Therefore, the alloy may be safe for those who wear glasses and have sensitive skin. The alloy also reduce the chance of an allergic reaction to Ni or V, and skin irritation or inflammation based upon the allergy, or a certain type of dementia due to Al. In addition, it is known that Cd and Tl are harmful to the human body. Furthermore, even if the Ti alloy is subjected to a great bending load, it may be able to instantaneously recover to its original shape due to its superelasticity. Also, even if the shape becomes deformed at a lower temperature, it can recover to its predetermined shape when it is warmed to approximately the room temperature. Therefore, it is possible to promote durability and maintain shape of the frame for a pair of glasses.

In addition, the Ti alloy may contain 20-60 wt % of Ta and 0.10-10 wt % of Zr. The remainder may contain Ti and impurities. This frame material for a pair of glasses may be safe for those who wear glasses and often suffer from skin irritation, inflammation, or other allergic reactions due to Ni or V, or dementia due to Al. In addition, the frame for a pair of glasses may have high corrosion and abrasion resistances, as well as the superelastic and shape-memory characteristics, and can accommodate an intensive movement.

Furthermore, the amount of Ta may be within the range of 20-60 wt % to impose the corrosion resistance and allow the Ti alloy to become a β phase. It becomes difficult to generate the β phase when the Ta amount is less than 20 wt %. On the other hand, when the Ta amount is in excess of 60 wt %, the melting point of the Ti alloy becomes excessively high, and a uniform β phase composition cannot be obtained. The workability of the material also decreases. The desirable Ta amount may be within the range of 40-60 wt %, and an uniform β single phase composition can be obtained within this range. Further, the Zr amount may be within the range of 0.01-10 wt % to improve mechanical characteristic of the Ti alloy. However, if the Zr amount is in excess of 10 wt %, it becomes brittle. Therefore, the above-mentioned range has been established.

In addition, the Ti alloy (Ti—Nb—Ta-base) may include one or two of 0.01-10 wt % of Mo, 0.01-15 wt % of Zr, and 0.01-15 wt % of Sn. In the case of using this material, it can realize a Ti frame for a pair of glasses where each of the above-mentioned characteristics is stabilized. Furthermore, when each of the above-mentioned elements is contained with less than its lower limit value, each of the above-mentioned characteristics cannot be obtained. If each of the above-mentioned element is contained in excess of its upper limit, each characteristic becomes saturated and the cost becomes high. Therefore, the above-mentioned ranges have been established.

Furthermore, in the present embodiment, the Ti alloy may include a total of 20-60 wt % of Nb and Ta. Also, this material may contain one or two of 0.01-10 wt % of Mo, 0.01-15 wt % of Zr, and 0.01-15 wt % of Sn. The remainder may contain Ti and impurities. By using of this material, one who wears glasses can be protected from skin irritation, inflammation, or other allergic reactions due to Ni or V, or dementia due to Al. In addition, it becomes possible to obtain a frame for a pair of glasses that has high corrosion resistance and abrasion resistance, as well as the superelastic and shape-memory characteristics, and that can accommodate to an intensive movement. Furthermore, it is desirable that the upper limit value of the amount of Nb and Ta be 50 wt %. In these elements, Nb may be used as an alternative element Ta, and it is desirable that it be contained 15 to 50 wt %. When the Nb content is 15 wt %, an a phase may be precipitated to the composition of the Ti alloy. On the other hand, when Nb is contained in excess of 50 wt %, its workability, such as ductility, starts deteriorating. Consequently, the above-mentioned range has been established, and it is desirable that the range may be 15-45 wt %. Further, it is desirable that Ta content be 6-20 wt %. This is because when the Ta content is 6 wt % or less, its workability, such as ductility, starts deteriorating. On the other hand, when Ta content is in excess of 20 wt %, the melting point of the Ti alloy becomes excessively high. Thus, it is desirable that the range be 6-15 wt %.

In addition, in the present embodiment, the Ti alloy may include 0.01-0.5 wt % of Pd. By using this material, it may be possible to improve the corrosion resistance of a frame for a pair of glasses formed from the frame material and to reduce changes of skin allergy generally.

Moreover, the superelasticity of the frame material for a pair of glasses may have 2% or more of the shape recovery elastic strain (εₑ). By using this material, even if a frame for a pair of glasses is subjected to an external force, it can instantaneously recover its original shape. Furthermore, the shape recovery elastic strain (εₑ) indicates a maximum strain amount within the limitation of the elastic deformation where an elastically deformed frame material for a pair of glasses completely recovers its original shape. Further, the desirable recovery strain (εₑ) may be 2.5% or more.

In addition, in the present embodiment, the frame material for a pair of glasses may also be treated with a plastic formation process with 90% or more of an area reduction factor. By the plastic formation process, a frame material for a pair of glasses may have the average particle diameter of the crystal grain of the Ti alloy with 10 μm or less. Therefore, it becomes possible to obtain a frame for a pair of glasses that may excel in terms of both strength and abrasion resistance.

Furthermore, where the cross-sectional area of the Ti alloy material before the plastic forming is X1 and the cross-section area after the plastic formation is X2, the above-mentioned reduction of area (reduction of cross-sectional area) can be expressed as (1=X2)/X1)×100%. Further more, the above-mentioned plastic factor process may include a process where the above-mentioned Ti alloy material, for example, is led through rollers with multiple groups of grooves, whose diameters become smaller in order, a process where the material is led through multiple groups of dies for wire drawing with gradually reduced diameters, and an obtained intermediate material with a reduced diameter is formed with a predetermined cross-sectional configuration using a press, a forging machine, or a rolling mill.

In addition, in the present embodiment, the frame material for a pair of glasses may be treated with at least one thermal treatment among a solution heat treatment, an aging treatment, and an annealing process after the above-mentioned plastic formation process.

By applying at least either of the above-mentioned solution heat treatment and the aging treatment the miniaturization of crystal grains in the β phase of the Ti alloy may be achieved. In addition, by applying at least one of the above-mentioned thermal treatments and the annealing process, the superelasticity and the shape-memory characteristics in the vicinity of the room temperature. Furthermore, the above-mentioned annealing process is a straightening annealing process that is performed within the range of, for example, 300-900° C.

A frame for a pair of glasses in the present embodiment may use the above-mentioned frame material for at least temples or a bridge. By using the frame for a pair of glasses, even if some sort of external force is received, the shape can instantaneously recover its original shape. Even if the shape becomes a deformed at a lower temperature, it can recover its predetermined shape by heating it close to the room temperature. Therefore, it may be possible to provide a frame for a pair of glasses that does not cause skin irritation due to a metal allergic reaction.

After the Ti alloy with the above-mentioned component composition combined with a predetermined amount of Ti, Nb and Ta or at lest one type of Pd, Mo, Zr and Sn is ingoted using a vacuum smelting furnace, and casted, an ingot of a Ti alloy that does not contain Ni, Al, and V was obtained.

After the ingot is re-fused, a raw material of Ti alloy with an approximately 8 mm of diameter was obtained by guiding the metal between rollers that have multiple grooves.

Next, a swaging process is performed by guiding the raw material of the above-mentioned Ti alloy between rollers that have multiple groups of grooves with reduced diameters. In addition, the material is led through multiple groups of dies for wire drawing, the taper hole with reduced diameter. During these processes, an intermediate annealing process is appropriately performed. Then, a plastic form action process intermediate raw material with a reduced diameter of approximately 2 mm was performed to form a material having a predetermined cross-sectional configuration using a press, a forging machine, or a rolling mill.

For example, as shown in FIG. 1, a pair of right and left temples 4R, 4L and joints between the temple and the rim 8R, 8L in the frame for a pair of glasses 1 in the present invention are molded to have an approximately rectangular cross-section with about 1 mm×about 2-3 mm. Further, a pair of right and left rims 2R, 2L, and a brace bar 6 and a bridge 7, which connect between these rims, for example, are molded to have a square-cross section or a rectangular cross-section with about 1 mm×about 1-2 mm.

The cross-section area reduction factor (hereafter referred to as ‘reduction of area’) from the plastic form process from the above-mentioned Ti alloy raw material to a frame material for a pair of glasses, such as the temples 4R, 4L, is 90% or more, and it is desirable that this factor be 95% or more.

Next, at least one of the thermal treatments among a solution heat treatment, an aging treatment, and an annealing process, is performed to the frame materials for a pair of glasses (the frame material of a pair of glasses in the present invention), which are at least the above-mentioned temples 4R, 4L, the brace bar 6, and the bridge 7, in an inert gas [atmosphere], such as Ar. The thermal treatment enables one or both of the superelasticity and the shape-memory characteristics in the vicinity of the room temperature (approximately −20° C. through approximately +60° C.) to the above-mentioned Ti—Ta—Zr-base and Ti—Ta—Nb-base alloys which form the frame construction material for a pair of glasses. It is presumed that the temperature range of the martensitic transformation of the above-mentioned Ti alloy leans toward a temperature lower than 0° C.

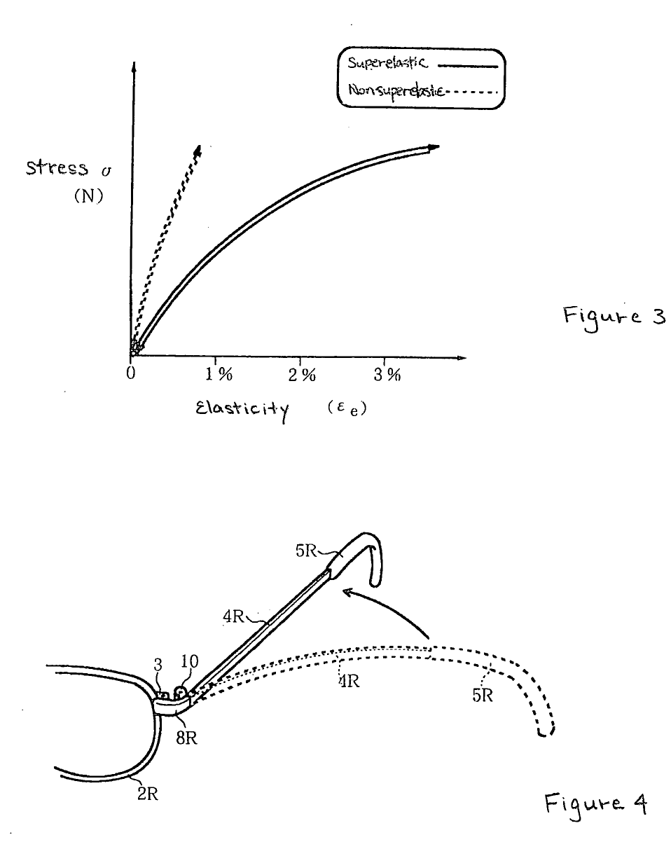

Superelasticity can be expressed with the shape recovery elastic strain (εₑ), which indicates recovery of the original frame shape after an elastic deformation by receiving a stress (σ) due to a load. As shown by the solid line in a graph that shows a tensile stress and the shape recovery elastic strain in FIG. 3, superelasticity is 2% or more, and desirably 2.5% or more. For a general material that does not have the superelasticity, as shown by the broken line in a graph of FIG. 3, the shape recovery elastic strain (εₑ) is within the range where the stress (σ) and the elastic deformation are proportional, and it is less than 1%.

The shape memory characteristic allows a frame material that is deformed by a stress (σ) due to a load and is subjected to a yield phenomenon (permanent strain) to recover to its original shape by heating it.

Furthermore, among the frames for a pair of glasses 1 shown in FIG. 1, since the above-mentioned superelasticity and shape-memory characteristics are not required for a pair of the right and left rims 2R, 2L and the right and left joints 8R, 8L, after the above-mentioned plastic form after process is performed, only the stress relief annealing process is performed at a comparatively low temperature of approximately 200° C.-500° C. Then, the brace bar 6 and the bridge 7 where at least either the superelasticity or the shape-memory characteristic is provided are brazed between the rims 2R and 2L via Ag brazing, as shown in FIG. 1.

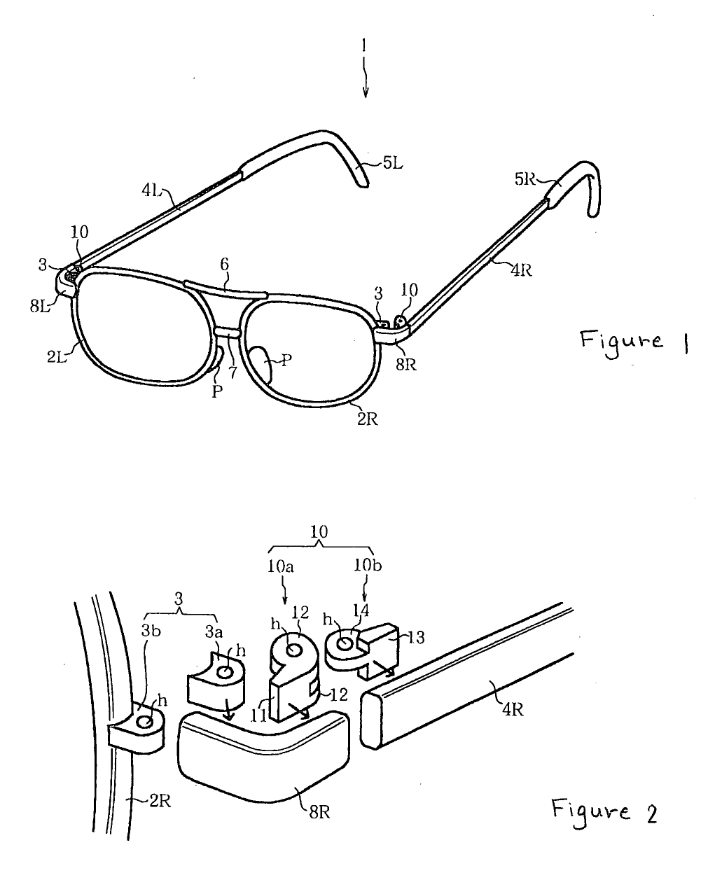

Furthermore, as shown in FIG. 2, the temples 4R, 4L are individually connected to one end of the joints 8R, 8L between the rims 2R, 2L and the temples 4R, 4L via a hinge 10. At the same time joints 8R, 8L are symmetrically connected to the external sides of the rims 2R, 2L via the rim lock 3. Further, pads p are installed to the rims 2R, 2L with a well-known methods, respectively. In addition, ear pads made of resin are secured at the ends of the temples 4R, 4L.

As shown in FIG. 2, the rim locks 3 are formed from a casting of the Ti alloy similar to the one mentioned above. The rims lock 3 includes the lower 3b which is brazed to the external side of the rims 2R, 2L and the upper portion 3a which is brazed to the internal side of the joints 8R, 8L. By screwing with screws (not shown) into female screw holes h individual connections of the joints 8R, 8L on the external sides of the rim 2R, 2L, respectively are connected.

Further, the hinge 10 is formed from a casting of the Ti alloy similar to the one mentioned above. As shown in FIG. 2, it includes a hinge part 10a, which includes a base 11 and a pair of upper and lower round parts 12 that horizontally project from the base 11, and another hinge part 10b, which includes a base 13 and a round part 14 that horizontally projects from the middle of the base 13. As shown by the arrow in FIG. 2, in the hinge part 10a, its base 11 is brazed to the joints 8R, 8L, respectively, and in the hinge 10b, its base 13 is brazed to the temples 4R, 4L, respectively.

Then, by screwing with screws (not shown) into the female screw holes h & h, in the hinge parts 10a, 10b the hinge 10 is formed. As shown in FIG. 1, the frame for a pair of glasses 1 that includes the temples 4R, 4L, the brace bar 6, and the bridge 7, which are formed from the above-mentioned Ti alloy that has superelasticity, can be obtained.

The frame for a pair of glasses 1 features superelasticity where, for example, even if the temple 4R along with the ear pad 5R are greatly bent outward, for example, as shown by the broken line in FIG. 4, releasing the finger causes instantaneous recovery to the original shape, as shown by the arrow in the drawing. Alternatively, the frame may have a shape-memory characteristic such that even if the shape has become deformed at a lower temperature for any reason, when it is warmed to the vicinity of room temperature, the shape recovers its predetermined shape. The frame may have both superelasticity and the shape-memory characteristics.

The specific embodiments of the frame materials for a pair of glasses in the present invention are explained next.

Ti alloy ingots for Embodiments 1-28, which do not contain Ai, Al and V may be obtained by casting of a Ti alloy with the component composition shown in Table 1 into a casting mold after individually ingoting using a vacuum fusion furnace.

After the relating ingots are re-fused, the ingots are passed between rollers that have multiple grooves, resulting obtaining the raw material of the Ti alloy with a 7.5 mm diameter.

Next, with respect to the raw materials of the Ti alloy for each embodiment, diameter reduction process (swaging processing: plastic forming) in which a material is passed between rollers that have multiple groups of grooves, whose diameter becomes smaller in order, is performed, and an intermediate raw material with a 2.2 mm of diameter is obtained. During this process, the intermediate annealing process is appropriately performed.

In addition, the plastic forming for the purpose of molding to specimens for the temple with 3 mm×0.8 mm of cross section and 135 mm of length is performed. The reduction of cross sectional area due to the entire plastic forming of each specimen for Embodiments 1-28 during the above-mentioned processes is shown in Table 1.

In addition, any of the thermal treatments among the solution heat treatment, the aging treatment and the annealing process is individually performed to each specimen for Embodiments 1-28 at the temperatures and time periods shown in Table 1.

On the other hand, ingoting and the plastic forming for the reduction of area, which is shown in Table 1, are performed to α+β type or β type Ti alloys for Comparative Examples 1-6, which are shown in Table 1, and specimens for a temple with a size similar to the above-mentioned are obtained; concurrently, the thermal treatments that are shown in Table 1 are individually performed to these specimens.

TABLE 1
Embodiment 1-28 and Comparison 1-6

| | | Area | Heat Treatment (Solution |
|---|---|---|---|
| | | Reduction | Heat Treatment, Aging |
| | | Factor | Treatment, and Annealing |
| No. | Alloy Composition (wt %) | (%) | Process (s)) |
| 1 | Ti - 18 Nb - 10 Ta - 2 Mo | 92 | 844° C. × 30 min. → 400° C. × 1 hr |
| 2 | Ti - 18 Nb - 10 Ta - 2 Mo | 94 | s 420° C. × 15 min. |
| 3 | Ti - 29 Nb - 13 Ta - 4 Mo | 93 | 844° C. × 30 min. → 420° C. × 1 hr |
| 4 | Ti - 29 Nb - 13 Ta - 4 Mo | 95 | s 420° C. × 20 min. |
| 5 | Ti - 16 Nb - 13 Ta - 7 Mo | 92 | 844° C. × 30 min. → 400° C. × 1 hr |
| 6 | Ti - 16 Nb - 13 Ta - 7 Mo | 94 | s 400° C. × 30 min. |
| 7 | Ti - 34 Nb - 20 Ta - 4.6 Zr | 93 | s 435° C. × 10 min. |
| 8 | Ti - 34 Nb - 20 Ta - 4.6 Zr | 94 | s 455° C. × 15 min. |
| 9 | Ti - 29 Nb - 13 Ta - 4.6 Zr | 95 | s 435° C. × 10 min. |
| 10 | Ti - 29 Nb - 13 Ta - 4.6 Zr | 95 | s 455° C. × 10 min. |
| 11 | Ti - 18 Nb - 20 Ta - 8 Zr | 97 | 844° C. × 30 min. → 480° C. × 1 hr |
| 12 | Ti - 18 Nb - 20 Ta - 8 Zr | 96 | s 480° C. × 10 min. |
| 13 | Ti - 29 Nb - 13 Ta - 2 Sn | 98 | 844° C. × 30 min. → 400° C. × 1 hr |
| 14 | Ti - 29 Nb - 13 Ta - 2 Sn | 94 | s 400° C. × 20 min. |
| 15 | Ti - 29 Nb - 13 Ta - 4.6 Sn | 97 | 844° C. × 30 min. → 420° C. × 1 hr |
| 16 | Ti - 29 Nb - 13 Ta - 4.6 Sn | 98 | s 420° C. × 15 min. |
| 17 | Ti - 29 Nb - 13 Ta - 6 Sn | 96 | 844° C. × 30 min. → 400° C. × 1 hr |
| 18 | Ti - 29 Nb - 13 Ta - 6 Sn | 98 | s 400° C. × 10 min. |
| 19 | Ti - 20 Nb - 13 Ta - 9 Sn | 94 | 844° C. × 30 min. → 450° C. × 1 hr |
| 20 | Ti - 20 Nb - 13 Ta - 9 Sn | 97 | s 450° C. × 10 min. |
| 21 | Ti - 29 Nb - 13 Ta - 4.6 Zr - | 96 | 844° C. × 30 min. → 450° C. × 1 hr |
| | 0.2 Pd | | |
| 22 | Ti - 29 Nb - 13 Ta - 4.6 Zr - | 98 | s 450° C. × 15 min. |
| | 0.2 Pd | | |
| 23 | Ti - 50 Ta - 1 Zr | 97 | 844° C. × 30 min. → 400° C. × 1 hr |
| 24 | Ti - 50 Ta - 1 Zr | 98 | s 520° C. × 10 min. |
| 25 | Ti - 50 Ta - 1 Zr - 0.2 Pd | 94 | 844° C. × 30 min. → 480° C. × 30 min |
| 26 | Ti - 50 Ta - 1 Zr - 0.2 Pd | 96 | s 480° C. × 10 min. |
| 27 | Ti - 29 Nb - 13 Ta - 4.6 Zr | 94 | s 380° C. × 30 min. |
| 28 | Ti - 29 Nb - 13 Ta - 4.6 Zr | 98 | s 520° C. × 10 min. |
| 1 | Ti - 6 Al - 4 V | 94 | 955° C. × 1 hr → 480° C. × 2 hr |
| 2 | Ti - 6 Al - 4 V | 98 | s 480° C. × 15 min. |
| 3 | Ti - 5 Al - 2.5 Fe | 92 | 955° C. × 1 hr → 520° C. × 2 hr |
| 4 | Ti - 5 Al - 2.5 Fe | 96 | s 520° C. × 10 min. |
| 5 | Ti - 13 Nb - 13 Zr | 95 | 775° C. × 1 hr → 425° C. × 2 hr |
| 6 | Ti - 13 Nb - 13 Zr | 97 | s 425° C. × 15 min. |

Four specimens are prepared for Embodiments 1-28 and Comparative Example 1-6, respectively, and the tension test, the 0.2% proof test, Rockwell hardness test, and the elastic deformation test are individually performed to these specimens. The results are shown in Table 2.

TABLE 2
Embodiment 1-28 and Comparison 1-6

| | | | | Elastic |
|---|---|---|---|---|
| | Tension Test | Proof Test | Hardness Test | Deformation Test |
| No. | (σ_{B}/MPa) | (σ_{0.2}/MPa) | (H_{RC}) | (εₑ) (%) |
| 1 | 776 | 564 | 41 | 2.8 |
| 2 | 989 | 852 | 40 | 2.7 |
| 3 | 598 | 591 | 39 | 2.9 |
| 4 | 597 | 592 | 41 | 2.8 |
| 5 | 634 | 550 | 42 | 2.6 |
| 6 | 1200 | 1170 | 39 | 2.9 |
| 7 | 415 | 410 | 38 | 2.5 |
| 8 | 419 | 417 | 43 | 2.8 |
| 9 | 522 | 245 | 36 | 2.9 |
| 10 | 574 | 330 | 37 | 2.4 |
| 11 | 480 | 455 | 36 | 3.0 |
| 12 | 572 | 558 | 40 | 3.3 |
| 13 | 562 | 397 | 41 | 3.2 |
| 14 | 1021 | 1000 | 44 | 3.1 |
| 15 | 527 | 453 | 46 | 2.6 |
| 16 | 1035 | 975 | 45 | 2.8 |
| 17 | 524 | 503 | 43 | 3.0 |
| 18 | 605 | 589 | 44 | 2.9 |
| 19 | 510 | 498 | 42 | 2.8 |
| 20 | 595 | 575 | 43 | 3.1 |
| 21 | 530 | 240 | 45 | 3.2 |
| 22 | 911 | 864 | 41 | 3.3 |
| 23 | 640 | 550 | 44 | 3.0 |
| 24 | 973 | 892 | 43 | 3.2 |
| 25 | 628 | 535 | 39 | 2.9 |
| 26 | 951 | 866 | 42 | 3.3 |
| 27 | 1010 | 999 | 41 | 2.7 |
| 28 | 923 | 689 | 40 | 2.9 |
| 1 | 896 | 827 | 30 | 0.6 |
| 2 | 953 | 822 | 33 | 0.7 |
| 3 | 901 | 843 | 32 | 0.6 |
| 4 | 943 | 886 | 33 | 0.5 |
| 5 | 798 | 599 | 31 | 0.4 |
| 6 | 994 | 864 | 35 | 0.5 |

As shown in Table 2, the specimens for Embodiments 1-28 show the following results:

Tensile strength (σ α): approximately 400-1200 Mpa;

0.2% proof stress: (α 0.2): approximately 400-1170 Mpa;

Hardness (H RC): 36-46; and

Shape recovery elastic strain (σ e): 2.4-3.3%.

On the other hand, the specimens for Comparative Examples 1-6 show the following results:

Tensile strength (σ a): approximately 800-approximately 1000 Mpa;

0.2% proof stress: (σ 0.2): approximately 600-approximately 900 Mpa;

Hardness (H RC): 30-35; and

Shape recovery elastic strain (σ e): 0.4-0.7%.

According to the above-mentioned results, specimens for Embodiments 1-28 may have the tensile strength and 0.2% proof stress, which are sufficient for a frame material for a pair of glasses, and have comparatively high level of hardness. At the same time, these have superelasticity in which the shape recover elastic strain (σ e) is 2% or more.

Therefore, the specimens for Embodiments 1-28 to a frame material for a pair of glasses, such as a temple or a bridge, should reduce skin irritation and provide superior durability so as to be able to instantaneously recover to its original shape even if receiving a casual external force.

The specimens for Comparative Example 1-6 contain elements that may adversely affect health, such as Al or V. When a casual external force is received, only slight elastic deformation occurs, and plastic deformation (permanent strain) may occur. Therefore, these are not suitable for a frame material for a pair of glasses.

In addition, each specimen for the above-mentioned Embodiments 1-28 (cross section: 3 mm×0.8 mm×length: 135 mm), which have been manufactured with each process as similar to the above-mentioned, are additionally manufactured, and with these specimens, 60 mm from one end is restrained and another end at the free side is bent to 50 degrees (permanent strain) in the environment of −60° C. When these specimens are warmed at the room temperature (25° C.), the shape-memory characteristic can be confirmed where all specimens recover to its original linear shape.

According to the above-mentioned embodiments, it is easily understood that the superior effects of the frame material for a pair of glasses according to the present invention are proven.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. An eyeglass frame, comprising a frame portion fabricated from a Ti alloy having at least one of a superelastic characteristic and a shape-memory characteristic, the Ti alloy being free from Ni.

2. The eyeglass frame of claim 1, wherein the Ti alloy is free from V, Al, Cd and Tl.

3. The eyeglass frame of claim 1, wherein the Ti alloy includes 20-60 wt % of Ta and 0.10-10 wt % of Zr.

4. The eyeglass frame of claim 2, wherein the Ti alloy includes 20-60 wt % of Ta and 0.10-10 wt % of Zr.

5. The eyeglass frame of claim 1, wherein the Ti alloy includes 20-60 wt % of Nb and Ta and at least one of 0.01-10 wt % Mo, 0.01-15 wt % of Zr, and 0.01-15 wt % of Sn.

6. The eyeglass frame of claim 2, wherein the Ti alloy includes 20-60 wt % of Nb and Ta and at least one of 0.01-10 wt % Mo, 0.01-15 wt % of Zr, and 0.01-15 wt % of Sn.

7. The eyeglass frame of claim 3, wherein the Ti alloy includes 0.01-0.5 wt % of Pd.

8. The eyeglass frame of claim 5, wherein the Ti alloy includes 0.01-0.5 wt % of Pd.

9. The eyeglass frame of claim 1, wherein the superelastic characteristic provides 2% or more of shape recovery elastic strain (εₑ).

10. The eyeglass frame of claim 7, wherein the superelastic characteristic provides 2% or more of shape recovery elastic strain (εₑ).

11. The eyeglass frame of claim 1, wherein the Ti alloy is treated with a plastic forming process with 90% or more of an area reduction factor.

12. The eyeglass frame of claim 9, wherein the Ti alloy is treated with a plastic forming process with 90% or more of an area reduction factor.

13. The eyeglass frame of claim 11, wherein the Ti alloy is subjected to at least one of a solution heat treatment, an aging treatment, and an annealing treatment after the plastic forming process.

14. The eyeglass frame of claim 12, wherein the Ti alloy is subjected to at least one of a solution heat treatment, an aging treatment, and an annealing treatment after the plastic forming process.

15. The eyeglass frame of claim 1, wherein the fame portion includes at least a temple portion and a bridge portion.

16. The eyeglass frame of claim 13, wherein the fame portion includes at least a temple portion and a bridge portion.
